(19) United States
(12) Patent Application Publication
(10) Pub. No.: US 2012/0208423 A1
(43) Pub. Date: Aug. 16, 2012

(54) Laminated Nonwoven Fabric

(76) Inventors: Mary Frances Mallory, Atlanta, GA (US); Juha P. Kemppinen, Cumming, GA (US)

(21) Appl. No.: 13/028,371

(22) Filed: Feb. 16, 2011

(51) Int. Cl. B32B 5/26

(52) U.S. Cl. 442/387; 442/381

(57) ABSTRACT

The present invention provides a nonwoven laminate having a first composite layer and a second composite layer. Both the first composite and second composite layers contain staple fibers and substantially continuous thermoplastic fibers. The each of the first and second composite layers have a first outer surface and a second outer surface, wherein a preponderance of the fibers at the first outer surface are the substantially continuous thermoplastic fibers, and a preponderance of the fibers at the second outer surface are the staple fibers. In addition, the second outer surface of the first composite layer is adjacent said one of the first or second outer faces of the second composite layer such that the first outer surface of the first composite layer forms a first side of the nonwoven laminate.

### FIELD OF THE INVENTION

The present invention generally relates to a laminate nonwoven fabric which is useable as a wiper.

### BACKGROUND OF THE INVENTION

In many applications, wipers need to have the capability to quickly absorb and hold large quantities of liquids, including both water and/or oil. In addition, wipers also need to have adequate strength and abrasion resistance so that the wipers will not tear, shred, or lint during typical use. Wipers desirably also have a feel that is agreeable to the touch of a user, including softness and drapability. Other features desirable in wipers, depending on use, is for the wipers leave behind a clean surface that is also free of streaks. Preferably, a wiper should be strong enough to be reused by wringing out any absorbed liquid.

Many different wiper configurations have been suggested in the prior art. Generally, it is desirable for the wiper to have all of the properties mentioned above, but some properties are typically sacrificed to improve other properties. There is a need in the art for a wiper that improved properties, in particular absorption and wicking, without sacrificing the other properties of the wiper.

### SUMMARY OF THE INVENTION

Generally stated, the present invention provides a nonwoven laminate which is useable as a wiper.

In one embodiment of the present invention, the present invention provides a nonwoven laminate having a first composite layer and a second composite layer. The first composite layer contains staple fibers and substantially continuous thermoplastic fibers. The first composite layer has a first outer surface and a second outer surface, wherein a preponderance of the fibers at the first outer surface of the first composite layer are the substantially continuous thermoplastic fibers, and a preponderance of the fibers at the second outer surface of the first composite layer are the staple fibers. The second composite layer contains staple fibers and substantially continuous thermoplastic fibers. The second composite layer has a first outer face and a second outer face, wherein a preponderance of the fibers at a first outer face of the second composite layer are the substantially continuous thermoplastic fibers, and a preponderance of the fibers at a second outer face of the second composite layer are staple fibers. In addition, the second outer surface of the first composite layer is adjacent said one of the first or second outer faces of the second composite layer such that the first outer surface of the first composite layer forms a first side of the nonwoven laminate.

In a further embodiment of the present invention, the first composite and the second composite layer are each hydroentangled composites.

In an additional embodiment of the present invention, the first outer face of the second composite layer is adjacent the second outer surface of the first composite layer.

In yet another embodiment of the present invention, the second outer face of the second composite layer is adjacent the second outer surface of the first composite layer.

### BRIEF DESCRIPTION OF THE DRAWINGS

FIG. 1A shows a laminated nonwoven fabric with the first face of the second composite layer in contact with the second surface of the first composite layer.

FIG. 1B shows a laminated nonwoven fabric with the second face of the second composite layer in contact with the second surface of the first composite layer.

FIG. 2 shows a schematic view of an exemplary process which may be used to manufacture the individual layers of the laminated nonwoven fabric.

FIG. 3 shows a schematic view of an exemplary process which may be used to join the individual layers of the laminated nonwoven fabric together.

FIG. 4 shows a schematic view of an alternative exemplary process which may be used to join the individual layers of the laminated nonwoven fabric together.

### DEFINITIONS

It should be noted that, when employed in the present disclosure, the terms “comprises”, “comprising” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As used herein, the term “staple fibers” means fibers that have a fiber length generally in the range of about 0.5 to about 150 millimeters.

The term “pulp”, as used herein, refers to fibers from natural sources such as woody and non-woody plants. Woody plants include, for example, deciduous and coniferous trees. Non-woody plants include, for example, cotton, flax, esparto grass, milkweed, straw, jute, hemp, and bagasse.

As used herein, the term “substantially continuous” filaments or fibers refers to filaments or fibers prepared by extrusion from a spinneret, including without limitation spunbonded and meltblown fibers. Substantially continuous filaments or fibers may have average lengths ranging from greater than about 20 centimeters to more than one meter, and up to the length of the web or fabric being formed. Additionally and/or alternatively, the definition of “substantially continuous” filaments or fibers includes those which are not cut prior to being formed into a nonwoven web or fabric, but which are later cut when the nonwoven web or fabric is cut.

As used herein, the term “nonwoven web” means a web having a structure of individual fibers or threads which are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters are usually expressed in microns, or in the case of staple fibers, denier. It is noted that to convert from osy to gsm, multiply osy by 33.91.

As used herein the term “spunbond fibers” refers to small diameter fibers of molecularly oriented polymeric material. Spunbond fibers may be formed by extruding molten thermoplastic material as fibers from a plurality of fine, usually circular capillaries of a spinneret with the diameter of the extruded fibers then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) may be achieved by various methods including, but not limited to, those described in commonly assigned U.S. Pat. No. 6,200,669 to Marmon et al. and U.S. Pat. No. 5,759,926 to Pike et al., each is hereby incorporated by reference in its entirety.

Meltblown nonwoven webs are prepared from meltblown fibers. As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers which may be continuous or discontinuous, are generally smaller than 10 microns in average diameter (using a sample size of at least 10), and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments which have been formed from at least two polymers extruded from separate extruders but spun together to form one fiber. Multicomponent fibers are also sometimes referred to as “conjugate” or “bicomponent” fibers or filaments. The term “bicomponent” means that there are two polymeric components making up the fibers. The polymers are usually different from each other, although conjugate fibers may be prepared from the same polymer, if the polymer in each component is different from one another in some physical property, such as, for example, melting point, glass transition temperature or the softening point. In all cases, the polymers are arranged in substantially constantly positioned distinct zones across the cross-section of the multicomponent fibers or filaments and extend continuously along the length of the multicomponent fibers or filaments. The configuration of such a multicomponent fiber may be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al.; the entire content of each is incorporated herein by reference. For two component fibers or filaments, the polymers may be present in ratios of 75/25, 50/50, 25/75 or any other desired ratios.

As used herein, the term “multiconstituent fibers” refers to fibers which have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils which start and end at random. Fibers of this general type are discussed in, for example, U.S. Pat. Nos. 5,108,827 and 5,294,482 to Gessner.

### DETAILED DESCRIPTION OF THE INVENTION

The invention will now be described in detail with reference to particular embodiments thereof. The embodiments are provided by way of explanation of the invention, and not meant as a limitation of the invention. For example, features described or illustrated as part of one embodiment may be used with another embodiment to yield still a further embodiment. It is intended that the present invention include these and other modifications and variations as come within the scope and spirit of the invention.

In the description below, the terms “first” and “second” are used to solely distinguish layers, surfaces, faces and sides of the individual composite layers of the laminate. The terms are not used to imply order of the layers, surfaces, faces or sides of the laminate nonwoven fabric or the individual composite layers.

The present invention provides a laminated nonwoven fabric that includes at least two composite layers, each composite layer containing both staple fibers and substantially continuous thermoplastic fibers. Each composite layer has a first surface or face and a second surface or face. The layers are attached to one another at bonded regions wherein thermoplastic fibers from each composite layer are fused to thermoplastic fibers from the other composite layer. The staple fibers and the substantially continuous thermoplastic fibers are desirably arranged such that a preponderance of the fibers at one surface or face of the composite layer are staple fibers while a preponderance of the fibers at the other surface or face are substantially continuous thermoplastic fibers.

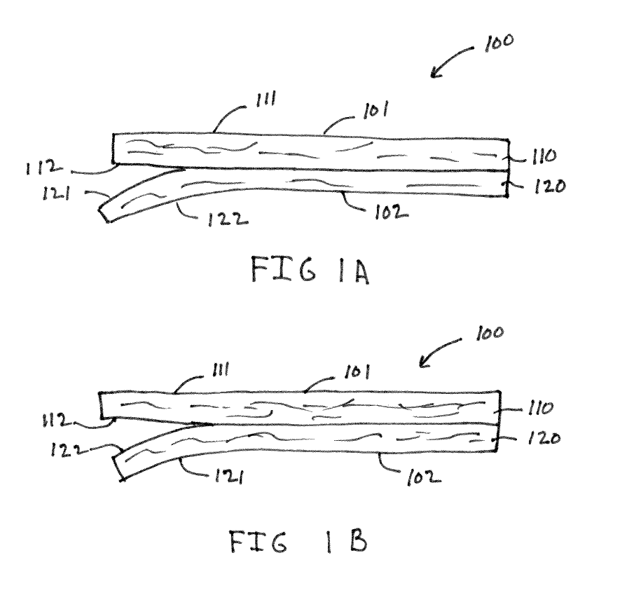

To gain a better understanding of the present invention and the orientation of the layers, attention is directed to FIGS. 1A and 1B. It is noted that the nonwoven laminate 100 is shown as having a second composite layer 120 peeled away from the first composite layer 110. But this is shown this way solely for the purpose of showing the relationship of the outer surfaces of each composite layer to the other composite layer. The actual layers of the nonwoven laminate will generally not peel back as is shown in FIGS. 1A, and 1B. As is shown in FIGS. 1A and 1B, the nonwoven laminate 100 has a first composite layer 110 and a second composite layer 120. The first composite layer 110 contains both staple fibers and substantially continuous thermoplastic fibers mixed together forming the composite layer. The first composite layer 110 has a first outer surface 111 and a second outer surface 112. A preponderance of the fibers at the first outer surface 111 of the first composite layer 110 are substantially continuous thermoplastic fibers, and a preponderance of the fibers at the second outer surface 112 of the first composite layer 110 are staple fibers. As used herein the term “preponderance” means that the majority (i.e. greater than 50% on a weight basis at the surface).

The second composite layer 120 of the nonwoven laminate is also a composite of staple fibers and substantially continuous thermoplastic fibers. The second composite layer 120 has a first outer 121 face and a second outer face 122. As with the first composite layer, a preponderance of the fibers at a first outer face 121 of the second composite layer 120 are the substantially continuous thermoplastic fibers, and a preponderance of the fibers at a second outer face 122 of the second composite layer 121 comprises staple fibers. The second composite layer 120 is joined to first composite layer 110 such that first outer surface 111 of the first composite layer 110 forms the first side 101 of the nonwoven laminate 100. This is shown in both FIGS. 1A and 1B.

In the present invention, as described herein, the first side 101 of the nonwoven laminate 100 is always the first outer surface 111 of the first composite layer 110. This way, the first side 101 of the nonwoven laminate 100 will always have surface where the preponderance of the fibers on the first side 101 of the nonwoven laminate 100 will be the substantially continuous thermoplastic fibers. By having substantially continuous thermoplastic fiber on the first side, the resulting nonwoven laminate have at least one other surface 101 which will be imparted with strength, durability, and may improve the oil absorption properties of the resulting nonwoven laminate. The orientation of the second composite layer 120 in relation to the first composite layer 110 determines the makeup of the second side 102 of the nonwoven laminate. As is shown in FIG. 1A, the first outer face 121 of the second composite layer 120 is adjacent the second outer surface 112 of the first composite layer 110. In this configuration, the second side 102 of the nonwoven laminate will have a preponderance of staple fibers. As shown in FIG. 1B, the second outer face 122 of the second composite layer 120 is adjacent the second outer surface 112 of the first composite layer 110. In this configuration, the second side 102 of the nonwoven laminate will have a preponderance of substantially continuous thermoplastic fibers. Again, by having the second side 102 of the nonwoven laminate 100 with a preponderance of the fibers at the surface being the substantially continuous thermoplastic fibers, as is shown in FIG. 1B, the second side 102 of the nonwoven laminate will also be imparted with strength, durability, and may improve the oil absorption properties of the resulting nonwoven laminate. When the second side 102 of the nonwoven laminate 100 is the second surface 122 of the second composite, the second side 102 of the nonwoven laminate 100 will have better hand feel and may improve the water absorption properties.

Those skilled in the art can select the configuration second composite layer 120 to the first composite layer 110. However, it has been discovered that having the a laminate where at least one of the outer surfaces contains a preponderance of the substantially continuous thermoplastic fibers, the resulting nonwoven laminate has improved wicking over a laminate where the inner adjacent layers contains the preponderance of substantially continuous thermoplastic fibers.

The substantially continuous thermoplastic fibers of the composite layers may be formed by known nonwoven extrusion processes, such as melt-spinning processes like spunbonding or meltblowing processes. The thermoplastic fibers may be formed from any solvent-spinnable or melt-spinnable thermoplastic polymer, co-polymers or blends thereof. Suitable polymers for the present invention include, but are not limited to, polyolefins, polyamides, polyesters, polyurethanes, blends and copolymers thereof, and so forth. Generally, the substantially continuous thermoplastic fibers are polyolefins fibers, typically, polypropylene and polyethylene fibers. Suitable fiber forming polymer compositions may additionally have thermoplastic elastomers blended therein as well as contain pigments, antioxidants, flow promoters, stabilizers, fragrances, abrasive particles, filler and the like. Optionally, multicomponent (e.g., bicomponent) thermoplastic fibers are utilized. For example, suitable configurations for the multicomponent fibers include side-by-side configurations and sheath-core configurations, and suitable sheath-core configurations include eccentric sheath-core and concentric sheath-core configurations. In some embodiments, as is well known in the art, the polymers used to form the multicomponent fibers have sufficiently different melting points to form different crystallization and/or solidification properties. The multicomponent fibers may have from about 20% to about 80%, and in some embodiments, from about 40% to about 60% by weight of the low melting polymer. Further, the multicomponent fibers may have from about 80% to about 20%, and in some embodiments, from about 60% to about 40%, by weight of the high melting polymer. The thermoplastic fibers may be round or any the suitable shape known to those skilled in the art, including but not limited to, bilobal, trilobal, and so forth. Generally, the substantially continuous thermoplastic fibers within a layer of the laminate will have a basis weight from about 8 to about 70 grams per square meter (gsm). More typically, the substantially continuous thermoplastic fibers will have a basis weight from about 10 gsm to about 35 gsm.

The staple fibers of each may be cellulosic fibers or non-cellulosic fibers. Some examples of suitable non-cellulosic fibers that can be used include, but are not limited to, both thermoplastic and thermosetting polymeric fibers. Examples of such included polyolefin fibers, polyester fibers, nylon fibers, polyvinyl acetate fibers, polyurethane fibers and mixtures thereof. Cellulosic staple fibers include for example, pulp, thermomechanical pulp, synthetic cellulosic fibers, modified cellulosic fibers, and the like. Cellulosic fibers may be virgin fibers or may be obtained from secondary or recycled sources. Some examples of suitable cellulosic fiber sources include virgin wood fibers, such as thermomechanical, bleached and unbleached softwood and hardwood pulps. Secondary or recycled cellulosic fibers may be obtained from office waste, newsprint, brown paper stock, paperboard scrap, etc., may also be used. Further, vegetable fibers, such as abaca, flax, milkweed, cotton, modified cotton, cotton linters, can also be used as the cellulosic fibers. In addition, synthetic cellulosic fibers such as, for example, rayon, viscose rayon and lyocell may be used. Modified cellulosic fibers are generally are composed of derivatives of cellulose formed by substitution of appropriate radicals (e.g., carboxyl, alkyl, acetate, nitrate, etc.) for hydroxyl groups along the carbon chain. The staple fibers of each nonwoven composite layer may be between 8 and 120 gsm of each nonwoven composite layer. Typically, the staple fibers will be between 10 and 60 gsm of each composite layer.

In a further embodiment, one or both of the composite layers may contain various materials such as, for example, activated charcoal, clays, starches, and superabsorbent materials. For example, these materials may be added to the non-thermoplastic absorbent staple fibers prior to their incorporation into the composite layer. Alternatively and/or additionally, these materials may be added to the composite layer after the non-thermoplastic absorbent staple fibers and thermoplastic fibers are combined. Useful superabsorbents are known to those skilled in the art of absorbent materials. Superabsorbents are desirably present at a proportion of up to about 50 grams of superabsorbent per 100 grams of fibers in the composite layer.

A variety of methods may be utilized to form the nonwoven composite material of each of the first and second composite layer 110 and 120. In one particular embodiment of the present invention, the each composite layer 110 and 120 is formed by integrally entangling the staple fibers with the substantially continuous thermoplastic fiber. A variety of entanglement methods may be used to entangle the fibers including hydraulic, air or mechanical entanglement. One particular method is to use hydroentangling to form hydroentangled nonwoven composite. Hydroentangling processes and hydroentangled composite webs containing various combinations of different fibers are known in the art. A typical hydroentangling process utilizes high pressure jet streams of water to entangle staple fibers and/or substantially continuous fibers to form a highly entangled consolidated fibrous structure, e.g., a nonwoven fabric. Hydroentangled nonwoven fabrics of staple length fibers and substantially continuous fibers are disclosed, for example, in U.S. Pat. No. 3,494,821 to Evans and U.S. Pat. No. 4,144,370 to Bouolton, which are incorporated herein in their entirety by reference thereto for all purposes. Hydroentangled composite nonwoven fabrics of a continuous filament nonwoven web and a pulp layer are disclosed, for example, in U.S. Pat. No. 5,284,703 to Everhart, et al. and U.S. Pat. No. 6,315,864 to Anderson, et al., which are incorporated herein in their entirety by reference thereto for all purposes.

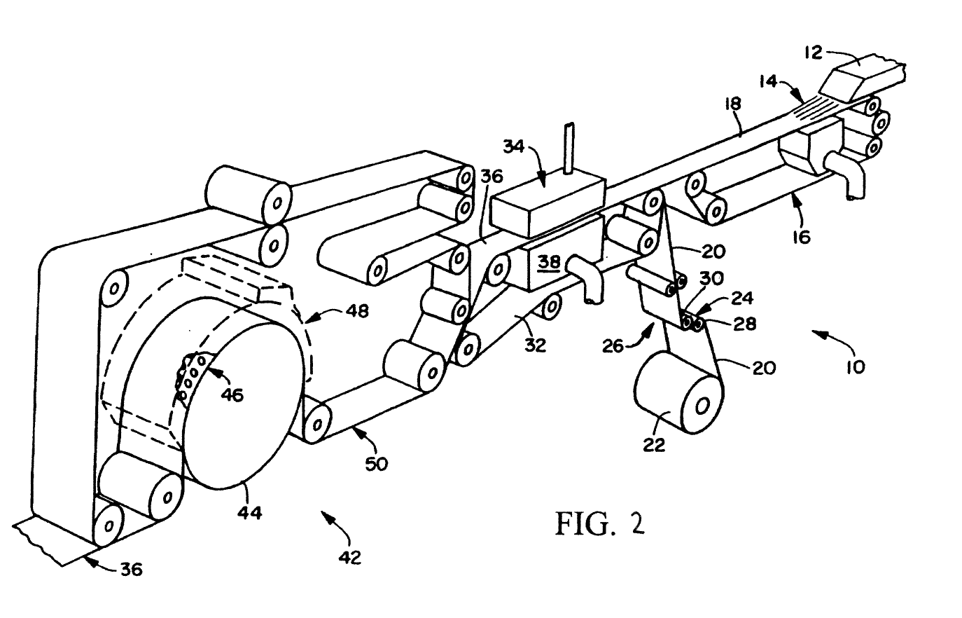

To gain a better understanding of the nonwoven composite which may be used to form the nonwoven laminate of the present invention, attention is directed to FIG. 2 of the drawings. Shown in FIG. 2 is a schematically illustrated exemplary process 10 for forming a hydroentangled composite fabric that can be used to form at least one of the composite layers of the nonwoven material of the present invention. In this process, staple fibers are supplied by a headbox 12 and deposited onto a forming fabric 16 of a conventional. The staple fibers may be wet laid, as shown in FIG. 2, from the head box 12 via a sluice 14 in a dispersion. However, while reference is made herein to formation of a staple fiber web by wet-forming processes, it is to be understood that the staple fiber web could alternatively be manufactured by other conventional processes such as for example, carding, airlaying, drylaying, and so forth. Generally, however, when absorbent staple fibers are used, the absorbent staple fibers will generally be wet laid.

When used, the suspension of staple fibers may be of any consistency that is typically used in conventional wet-forming processes. For example, the suspension may contain from about 0.01 to about 1.5 percent by weight staple fibers suspended in water. Water is removed from the suspension of staple fibers to form a uniform layer of staple fibers 18. The staple fiber layer 18 may have, for example, a dry basis weight from about 10 to about 120 grams per square meter (gsm). Generally, the staple fiber layer 18 has a dry basis weight from about 10 to about 60 gsm.

In this embodiment, the staple fibers may be of any average fiber length suitable for use in conventional wet forming processes. By way of nonlimiting example, northern softwood Kraft pulp fiber is a staple fiber that is suitable for use in a wet forming process. As a nonlimiting example, the staple fibers may have an average fiber length from about 1.5 mm to about 15 mm. Desirable pulp fibers include those having lower average fiber lengths including, but not limited to, certain virgin hardwood pulps and secondary (i.e. recycled) fiber pulp from sources such as, for example, newsprint, reclaimed paperboard, office waste, and so forth. Pulp fibers from these sources typically have an average fiber length of less than about 1.2 mm, for example, from 0.7 mm to 1.2 mm. Other suitable staple fibers include, but are not limited to, acetate staple fibers, rayon staple fibers, and so forth.

In one particular embodiment of the present invention, the staple fibers will contain between about 1% and about 40% by weight thermoplastic staple fibers with the remainder of the staple fibers being absorbent staple fibers such as pulp and the like. Generally, the amount of thermoplastic staple fibers is in the range of about 3-15% by weight. Suitable thermoplastic staple fibers include staple fibers from polymers which include, but are not limited to, polyolefins, polyamides, polyesters, polyurethanes, blends and copolymers thereof, and so forth. The thermoplastic staple fibers may be multicomponent staple fibers, For example, suitable configurations for the multicomponent staple fibers include side-by-side configurations and sheath-core configurations, and suitable sheath-core configurations include eccentric sheath-core and concentric sheath-core configurations. In some embodiments, as is well known in the art, the polymers used to form the multicomponent staple fibers have sufficiently different melting points to form different crystallization and/or solidification properties. The multicomponent fibers may have from about 20% to about 80%, and in some embodiments, from about 40% to about 60% by weight of the low melting polymer. Further, the multicomponent fibers may have from about 80% to about 20%, and in some embodiments, from about 60% to about 40%, by weight of the high melting polymer. The thermoplastic staple fibers may be round or any the suitable shape known to those skilled in the art, including but not limited to, bilobal, trilobal, and so forth.

When pulp fibers are used in the present invention, they may be unrefined or may be beaten to various degrees of refinement. Wet-strength resins and/or resin binders may be added to improve strength and abrasion resistance as desired. Useful binders and wet-strength resins are known to those skilled in the papermaking art. Cross-linking agents and/or hydrating agents may also be added to the pulp. Debonding agents may be added to the pulp to reduce the degree of hydrogen bonding if a very open or loose pulp fiber web is desired. Useful debonding agents are known to those skilled in the papermaking art. The addition of certain debonding agents also may reduce the static and dynamic coefficients of friction. The debonder is believed to act as a lubricant or friction reducer.

To produce one of the composite layers of the laminate, referring back to FIG. 2 of the drawings, a substantially continuous thermoplastic fiber substrate 20 is unwound from a supply roll 22. The thermoplastic fiber substrate 20 passes through a nip 24 of an S-roll arrangement 26 formed by the stack rollers 28 and 30. In an alternate embodiment (not shown) the nonwoven substrate could be made in-line prior to being directed to the nip 24. The precise arrangement of the rollers is not critical to the present invention.

The thermoplastic fiber substrate 20 may generally have a basis weight from about 10 to about 70 gsm. Typically, the thermoplastic fiber substrate 20 will have a basis weight from about 10 to about 35 gsm. The polymers that comprise the thermoplastic fiber substrate may include additional materials such as, for example, pigments, antioxidants, flow promoters, stabilizers and so forth.

The thermoplastic fiber substrate 20 may be bonded to improve its durability, strength, hand, aesthetics and/or other properties. For instance, the thermoplastic fiber substrate 20 may be thermally, ultrasonically, adhesively and/or mechanically bonded. As an example, the thermoplastic fiber substrate 20 may be point bonded such that it possesses numerous small, discrete bond points. An exemplary point bonding process is thermal point bonding, which generally involves passing one or more layers between heated rolls, such as an engraved patterned roll and a second bonding roll. The engraved roll is patterned in some way so that the web is not bonded over its entire surface, and the second roll may be smooth or patterned. As a result, various patterns for engraved rolls have been developed for functional as well as aesthetic reasons. Exemplary bond patterns include, but are not limited to, those described in U.S. Pat. Nos. 3,855,046 to Hansen, et al., 5,620,779 to Levy, et al., 5,962,112 to Haynes, et al., 6,093,665 to Savovitz, et al., U.S. Design Pat. No. 428,267 to Romano, et al. and U.S. Design Pat. No. 390,708 to Brown, which are incorporated herein in their entirety by reference thereto for all purposes. For instance, in some embodiments, the thermoplastic fiber substrate 20 may be optionally bonded to have a total bond area of less than about 30% (as determined by conventional optical microscopic methods) and/or a uniform bond density greater than about 100 bonds per square inch. For example, the nonwoven web may have a total bond area from about 2% to about 30% and/or a bond density from about 250 to about 750 pin bonds per square inch. Such a combination of total bond area and/or bond density may, in some embodiments, be achieved by bonding the thermoplastic fiber substrate 20 with a pin bond pattern having more than about 100 pin bonds per square inch that provides a total bond surface area less than about 30% when fully contacting a smooth anvil roll. In some embodiments, the bond pattern may have a pin bond density from about 250 to about 500 pin bonds per square inch and/or a total bond surface area from about 10% to about 25% when contacting a smooth anvil roll.

Further, the thermoplastic fiber substrate 20 may be bonded by continuous seams or patterns. As additional examples, the thermoplastic fiber substrate 20 may be bonded along the periphery of the sheet or simply across the width or cross-direction (CD) of the web adjacent the edges. Other bond techniques, such as a combination of thermal bonding and latex impregnation, may also be used. Alternatively and/or additionally, a resin, latex or adhesive may be applied to the thermoplastic fiber substrate 20 by, for example, spraying or printing, and dried to provide the desired bonding. Still other suitable bonding techniques may be described in U.S. Pat. Nos. 5,284,703 to Everhart, et al., 6,103,061 to Anderson, et al., and 6,197,404 to Varona, which are incorporated herein in its entirety by reference thereto for all purposes.

The staple fibers layer 18 is then laid on the thermoplastic fiber substrate 20 which rests upon a foraminous entangling surface 32 of a conventional hydraulic entangling machine. It is desirable that the staple fiber layer 18 is between the thermoplastic fiber substrate 20 and the hydraulic entangling manifolds 34. The staple fiber layer 18 and thermoplastic fiber substrate 20 pass under one or more hydraulic entangling manifolds 34 and are treated with jets of fluid to entangle the staple fibers with the thermoplastic fiber substrate 20. The jets of fluid also drive staple fibers into and through the thermoplastic fiber substrate 20 to form the composite material 36.

Alternatively, hydraulic entangling may take place while the staple fiber layer 18 and thermoplastic fiber substrate 20 are on the same foraminous screen (i.e., mesh fabric) upon which the wet-laying took place. Alternatively, a dried staple sheet can be superposed on a thermoplastic fiber substrate, re-hydrated to a specified consistency and then subjected to hydraulic entangling.

The hydraulic entangling may take place while the staple fiber layer 18 is highly saturated with water. For example, the staple fiber layer 18 may contain up to about 90 percent by weight water just before hydraulic entangling. Alternatively, the staple fiber layer may be an air-laid or dry-laid layer of staple fibers.

The hydraulic entangling may be accomplished utilizing conventional hydraulic entangling processes and equipment such as, for example, those found in U.S. Pat. No. 5,284,703 to Everhart et al., and U.S. Pat. No. 3,485,706 to Evans, the entire contents of which is incorporated herein by reference. The hydraulic entangling may be carried out with any appropriate working fluid such as, for example, water. The working fluid flows through a manifold that evenly distributes the fluid to a series of individual holes or orifices that may be, by way of nonlimiting example, from about 0.07 millimeters to about 0.4 millimeters in diameter. Many other manifold configurations and combinations known to those skilled in the art may be used. For example, a single manifold may be used or several manifolds may be arranged in succession.

In the hydraulic entangling process, the working fluid desirably passes through the orifices at a pressures ranging from about 1,300 to about 25,000 kPa. At the upper ranges of the described pressures it is contemplated that the composite fabrics may be processed at speeds of about 300 meters per minute. The fluid impacts the staple fiber layer 18 and the thermoplastic fiber substrate 20 which are supported by the foraminous entangling surface 32 which may be, for example, a single plane mesh having a mesh size of from about 40×40 to about 100×100. The foraminous entangling surface 32 may also be a multi-ply mesh having a mesh size from about 50×50 to about 200×200. As is typical in many water jet treatment processes, vacuum slots 38 may be located directly beneath the hydraulic entangling manifolds 34 or beneath the foraminous entangling surface 32 downstream of the hydraulic entangling manifold 34 so that excess water is withdrawn from the hydraulically entangled composite material 36.

Although not to be held to any particular theory of operation, it is believed that the columnar jets of working fluid which directly impact the staple fibers 18 laying on the substantially continuous thermoplastic fiber substrate 20 work to drive those fibers into and partially through the matrix or nonwoven network of fibers in the substantially continuous thermoplastic fiber substrate. When the fluid jets and staple fibers interact with the substantially continuous thermoplastic fiber substrate, the staple fibers are entangled with fibers of the substantially continuous thermoplastic fiber substrate and with each other. The degree of entanglement that may be achieved is dependent upon the degree to which the thermoplastic fibers have been bonded together. If the substantially continuous thermoplastic fiber substrate is too loosely bonded, the filaments are generally too mobile to form a coherent matrix to secure the staple fibers. On the other hand, if the total bond area of the substantially continuous thermoplastic fiber substrate is too great, the staple fiber penetration may be poor. Moreover, too much bond area will also cause a non-uniform composite fabric because the jets of fluid will splatter, splash and wash off staple fibers when they hit the large non-porous bond spots. The appropriate levels of bonding, as described above, provide a coherent substantially continuous thermoplastic fiber substrate that may be formed into a fabric suitable for us as a composite layer in the nonwoven material of the present invention by hydraulic entangling on only one side and still provide a strong, useful fabric as well as a composite fabric having desirable dimensional stability.

The energy of the fluid jets that impact the staple fiber layer and the substantially continuous thermoplastic fiber substrate can be adjusted so that the staple fibers are inserted into and entangled with the substantially continuous thermoplastic fiber substrate in a manner that enhances the two-sidedness of the resulting composite layer. That is, the entangling can be adjusted to produce a material of which a preponderance of the fibers on one surface are staple fibers and a preponderance of the fibers on the opposite surface are the substantially continuous thermoplastic fibers.

After the fluid jet treatment, the composite fabric 36 may optionally be transferred to a drying operation, desirably a non-compressive drying operation. If desired, the composite fabric may be wet-creped before being transferred to the drying operation. Non-compressive drying of the web may be accomplished utilizing a conventional rotary drum through-air drying apparatus shown in FIG. 2 at 42. The through-dryer 42 may be an outer rotatable cylinder 44 with perforations 46 in combination with an outer hood 48 for receiving hot air blown through the perforations 46. A through-dryer belt 50 carries the composite web 36 over the upper portion of the through-dryer outer cylinder 40. The heated air forced through the perforations 46 in the outer cylinder 44 of the through-dryer 42 removes water from the composite fabric 36. The temperature of the air forced through the composite web 36 by the through-dryer 42 may vary in accord with the line speed, percent saturation, atmospheric conditions, etc. The drying air may be heated or at ambient temperature. Other useful through-drying methods and apparatus may be found in, for example, U.S. Pat. No. 2,666,369 to Niks and U.S. Pat. No. 3,821,068 to Shaw, the entire contents of each of the aforesaid references being incorporated herein by reference.

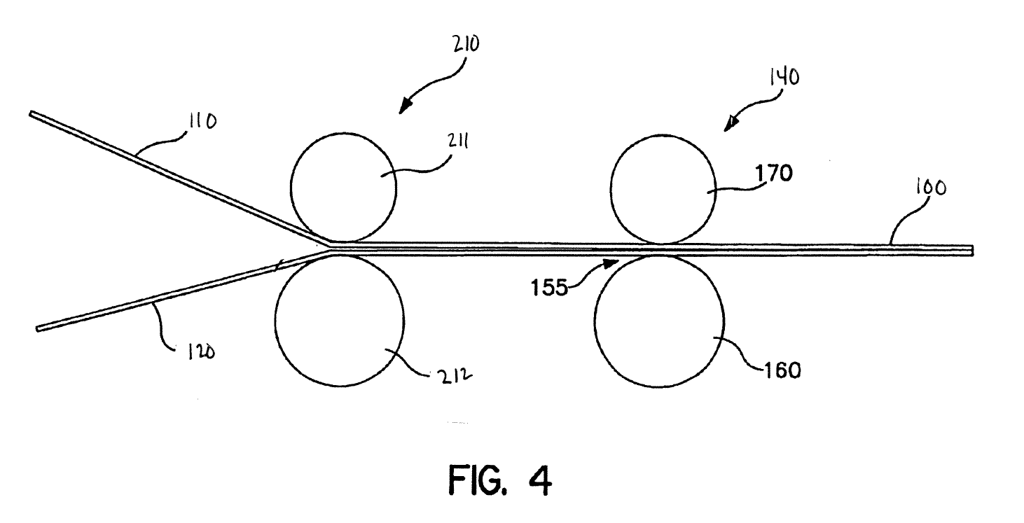

Two of the composite nonwoven webs are joined together to form the nonwoven laminate fabric of the present invention. One particular method of bonding the first and second composite layers 110, 120 together is to ultrasonic bonding. Ultrasonic bonding by way of a stationary horn and a rotating patterned anvil roll are known in the art and are taught, for example, in U.S. Pat. No. 3,939,033 to Grgach et al., U.S. Pat. No. 3,844,869 to Rust Jr., and U.S. Pat. No. 4,259,399 to Hill, the entire contents of each of the aforesaid references being incorporated herein by reference. It is also contemplated that the materials of the present invention can be produced by using an ultrasonic bonding apparatus that includes a rotary horn 160, as is shown in FIG. 4, and is described in more detail below, with a rotating patterned anvil roll as is taught, for example, in U.S. Pat. No. 5,096,532 to Neuwirth et al., U.S. Pat. No. 5,110,403 to Ehlert, and U.S. Pat. No. 5,817,199 to Brennecke et al., the entire contents of each of the aforesaid references being incorporated herein by reference. However, while specific ultrasonic bonders have been identified above, still other bonders are believed suitable for use in the present invention.

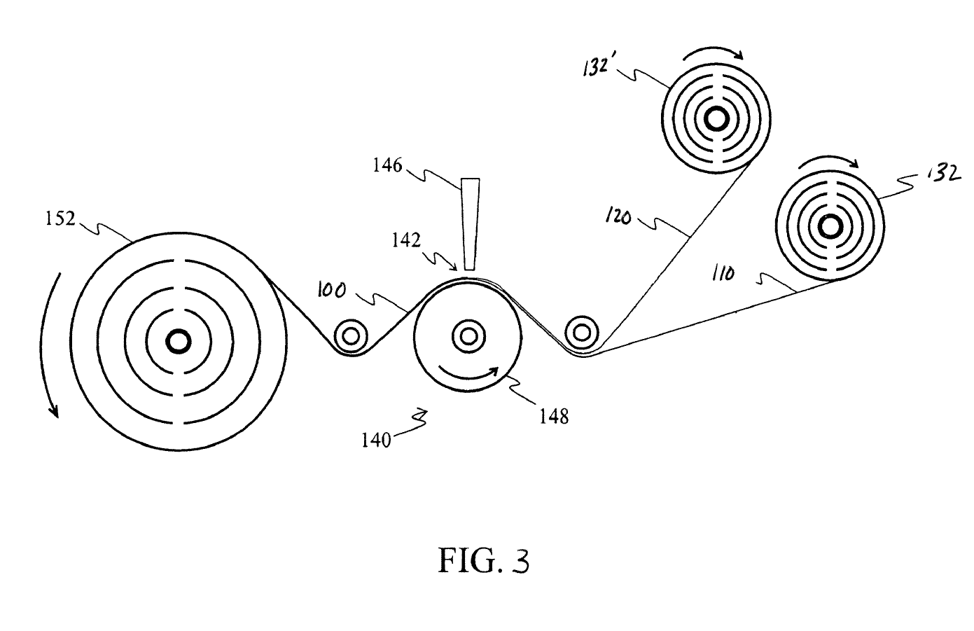

The nonwoven laminate fabric can be produced, for example, according to the process depicted in FIG. 3. First and second composite layers 110, 120, as described above, are unwound from first and second base rolls 132, 132′ and fed into a nip 142 of an ultrasonic laminator 140. The nip 142 of the ultrasonic laminator 140, as shown in FIG. 3, is formed between a stationary ultrasonic horn 146 and a rotating anvil roll 148. Generally speaking, the anvil roll 148 may possess any desired pattern that provides sufficient points or areas to allow the thermoplastic material to melt, flow, bond and solidify. One example of a suitable ultrasonic laminator, for instance, is the Branson Ultrasonic Unit, model number 2000BDC, which is commercially available from Branson Ultrasonic Corporation of Danbury, Conn. and has 6-inch stationary horns.

Any number of design patterns may be used on the anvil roll 148. Many are available that provide sufficient points or areas to allow the thermoplastic material to melt, flow, bond and solidify. Patterns can be chosen that provide desirable visual appearance, for non-limiting example, a cloth-like appearance. Exemplary patterns include, but are not limited to, those taught in U.S. Pat. No. D369,907 to Sayovitz et al., U.S. Pat. No. D428,267 to Romano III et al., and U.S. Pat. No. D428,710 to Romano III et al., the entire contents of each of the aforesaid reference being incorporated herein by reference.

The composite layers 110, 120 are bonded together within the nip 142 to form a nonwoven laminate fabric 100. Once bonded within the nip 142, the resulting nonwoven laminate fabric 100 may wound into a final base roll 152, as is shown in FIG. 3. Alternatively, the nonwoven laminate fabric 100 may be transferred to subsequent finishing and/or post treatment processes to impart selected properties to the nonwoven laminate fabric 100. For example, the nonwoven laminate fabric 100 may be lightly pressed by calender rolls, creped, embossed, debulked, rewound, or brushed to provide a uniform exterior appearance and/or certain tactile properties. Alternatively and/or additionally, chemical post-treatments such as, adhesives or dyes may be added to the nonwoven laminate fabric 100. It should also be understood that the first and/or second composite layers 110, 120 may be independently subjected to such finishing and/or post-treatment processes prior to lamination.

In another embodiment of the present invention, the one or both of the first or second composite layers may be pre-heated prior to bonding to the other composite layer, as is shown in FIG. 4. There may be advantages associated with preheating the materials prior to entering the main ultrasonic bonding apparatus may include increased bond strength of the composite layer 110 and 120 together. The method in accordance with this embodiment of this invention begins with preheating one or both of the composite layers. When one or both of the first or second composite layer is preheated prior to bonding, in accordance with one embodiment of this invention, a first composite 110 and/or a second composite 120 may each be passed through a preheating unit 210. The composites 110, 120 may pass through a heating unit which may preheat the first and/or second composites using heating methods such as an hot air oven, heated blocks, heated rollers, ultrasound, infrared, laser, RF, microwaves, and other similar methods which will effectively preheat the composite. As shown in FIG. 4, the preheating unit is a pair of heated rollers 211 and 212. Suitably, the composites 110, 120 or at least a portion of each web, is generally preheated to an initial or preheating temperature of at least about 90° F., desirably to a temperature of about 130° F. to about 250° F., and more desirably about 160° F. to about 250° F. In accordance with certain embodiments of this invention, the composites 110, 120 may be heated to a preheating temperature greater than about 250° F., if desired, provided that the temperature does not cause deformation or overheating of the materials used to make the composite layers 110, 120.

As is shown in FIG. 4, the preheated first and/or second composites 110, 120 are passed through the main ultrasonic bonding means 140. The main ultrasonic bonding means 140 may be any suitable ultrasonic bonding apparatus, such as a plunge ultrasonic bonding apparatus or a rotary ultrasonic bonding apparatus. Suitable rotary ultrasonic bonding apparatus include such apparatus as disclosed in U.S. Pat. No. 5,096,532 and U.S. Pat. No. 5,110,403, the disclosures of which are incorporated herein by reference. For example, the main ultrasonic bonding means 140 may be a rotary ultrasonic bonding apparatus having a vibrating ultrasonic horn 160 and a patterned anvil 170 having a plurality of pins positioned on a peripheral surface of the patterned anvil 170 and forming a pin pattern. As the preheated first and second composites 110, 120 are passed through a nip 155 formed between the vibrating ultrasonic horn 160 and the patterned anvil 170, the vibrating horn 160 compresses against the pins of the patterned anvil 170. The pattern of the patterned anvil roll 170 may be the same or similar pattern as the anvil roll 146. The ultrasonic vibrations are mechanically converted to heat under pressure resulting in material flow and fusion over times as short as a few milliseconds.

Within the main ultrasonic bonding means 140, whether by a stationary horn or a rotating horn, the first and second composites 110, 120 are ultrasonically bonded together and a laminate material 100, containing the first and second composites 110, 120 connected by at least one ultrasonic bond, exits the main ultrasonic bonding means 140. As a result of passing the first and second composites 110, 120 through the preheating unit 210, ultrasonic bonds having a predetermined bond strength can be formed during the ultrasonic bonding process to connect the first and second composites 110 and 120.

Generally, the first and second composites 110, 120 are passed through the ultrasonic bonding means 140 at a production line speed of about 0 ft./min. to at least about 1000 ft./min. having a bonding time or dwell time of about 1 millisecond (msec) to about 100 msec, depending upon the ultrasonic bonding apparatus utilized. The bonding time or the dwell time is defined as the amount of time that the first and second composites 110, 120 are positioned between the vibrating ultrasonic horn 146 or 160 and the anvil 148, 170. Of course, the line speed and bonding time may vary greatly depending on the particular process components and objectives.

The bonded regions between the composite layers desirably provide sufficient strength to reduce the probability of delamination during use. A peel strength test is used to determine the bond strength between component layers of bonded or laminated fabrics. Desirably, the peel strength ranges from about 50 grams to about 500 grams. More desirably, the peel strength ranges from about 50 grams to about 300 grams, and even more desirably the peel strength ranges from about 50 grams to about 200 grams. The capability to achieve desirable peel strengths without the formation of substantially polymer-filled bond points also provides an improved feel to the wiper material that manifests itself in increased drapability and/or softness. Thus, the nonwoven fabrics of the present invention are produced utilizing an ultrasonic bonding process that provides sufficient ply strength, yet yields an open structure within the bonded regions. The structure is open in all three dimensions. It allows flow not only from the outside of the bonded region to the inside of the bonded region, i.e., the z-direction, but also allows flow laterally in the x- and y-directions. The process also provides a softness, hand and/or drape that otherwise is not found in thermally bonded materials. Desirably, these properties are achieved through selection and use of high ultrasonic power output, high line speed, and low nip pressure. High ultrasonic power output allows the energy to penetrate the composite layers and fuse the thermoplastic fibers in the middle region of the nonwoven fabric. High line speed reduces dwell time and reduces the potential for excessive bonding that can result in burning and/or hole formation. Low nip pressure reduces the compression of the fibers within the bonded regions and avoids the complete loss of voids as well.

The composite layers 110, 120 that are plied together will generally have a sidedness as described above. One surface of each composite layer 130 has a preponderance of the substantially continuous thermoplastic fibers, while the opposite surface has a preponderance of staple fibers. That is one surface 111 of the nonwoven laminate of the present invention will have a preponderance of substantially continuous thermoplastic fibers, will the other surface 112 may either have a preponderance of staple fibers, as is shown in FIG. 1A or the other surface 112 may have a preponderance of substantially continuous thermoplastic fibers, as is shown in FIG. 1B. In addition to this sidedness that ultrasonic lamination of the composite layers may impart in a distinctive sidedness to the resulting nonwoven fabric. During lamination, the patterned anvil roll provides a rough surface texture to the side of the laminated material that contacts the patterned anvil roll during the bonding step. This surface texture can aid in the scrubbing, removal and entrapment of debris from a surface being cleaned. The rough surface texture also provides a larger surface area with a repetitive textured geometry that aids in the removal and entrapment of high viscosity liquids onto the surface of the nonwoven fabric and facilitates wicking into the surface of the nonwoven fabric. From the surface of the nonwoven fabric, the liquids can then be absorbed in the z-direction into the center core of the nonwoven fabric. Nonwoven fabrics that have not been laminated or embossed can exhibit a relatively smooth texture on both sides of the material that does not provide this attribute.

The nonwoven fabric of the present invention is particularly useful as a wiper material. An exemplary wiper material desirably has a basis weight ranging from about 30 gsm to about 500 gsm. More desirably, exemplary wiper materials have basis weights ranging from about 40 gsm to about 50 gsm, from about 50 gsm to about 60 gsm, from about 60 gsm to about 75 gsm, from about 75 gsm to about 100 gsm, from about 100 gsm to about 150 gsm, from about 150 gsm to about 200 gsm, from about 200 gsm to about 250 gsm or from about 250 gsm to about 500 gsm. Even more desirably, an exemplary wiper material has a basis weight ranging from about 50 gsm to about 130 gsm. Lower basis weight products are typically well suited for use as light duty wipers, while higher basis weight products are well suited as industrial wipers.

The wipers can be of any size, and the size can be selected as appropriate for a variety of wiping tasks. An exemplary wiper desirably has a width from about 8 centimeters to about 100 centimeters, more desirably has a width from about 10 to about 50 centimeters, and even more desirably has a width from about 20 centimeters to about 25 centimeters. An exemplary wiper generally has a length from about 10 centimeters to about 200 centimeters; more typically has a length from about 20 centimeters to about 100 centimeters, and even more typically has a length from about 35 centimeters to about 45 centimeters. The wipers can be packaged in a variety of forms, materials and/or containers, including, but not limited to, rolls, boxes, tubs, flexible packaging materials, and so forth. The packages desirably contain from about 10 to about 500 wipers per package, and more desirably contain from about 50 to about 200 wipers per package. The wipers within a package may be folded in a variety of ways, including, but not limited to interfolded, C-folded, and so forth.

If desired, the wiper may also be pre-moistened with a liquid, such as water, a waterless hand cleanser, or any other suitable liquid. The liquid may contain antiseptics, fire retardants, surfactants, emollients, humectants, and so forth. In one embodiment, for example, the wiper may be applied with a sanitizing formulation, such as described in U.S. Pat. No. 7,838,447 to Clark, et al., which is incorporated herein in its entirety by reference thereto for all purposes. The liquid may be applied by any suitable method known in the art, such as spraying, dipping, saturating, impregnating, brush coating and so forth. The amount of the liquid added to the wiper may vary depending upon the nature of the composite fabric, the type of container used to store the wipers, the nature of the liquid, and the desired end use of the wipers. Generally, each wiper contains from about 150 to about 600 wt. %, and in some embodiments, from about 300 to about 500 wt. % of the liquid based on the dry weight of the wiper.

In one embodiment, the wipers are provided in a continuous, perforated roll. Perforations provide a line of weakness by which the wipers may be more easily separated. For instance, in one embodiment, a 6″ high roll contains 12″ wide wipers that are v-folded. The roll is perforated every 12 inches to form 12″×12″ wipers. In another embodiment, the wipers are provided as a stack of individual wipers. The wipers may be packaged in a variety of forms, materials and/or containers, including, but not limited to, rolls, boxes, tubs, flexible packaging materials, and so forth. For example, in one embodiment, the wipers are inserted on end in a selectively resealable container (e.g., cylindrical). Some examples of suitable containers include rigid tubs, film pouches, etc. One particular example of a suitable container for holding the wipers is a rigid, cylindrical tub (e.g., made from polyethylene) that is fitted with a re-sealable air-tight lid (e.g., made from polypropylene) on the top portion of the container. The lid has a hinged cap initially covering an opening positioned beneath the cap. The opening allows for the passage of wipers from the interior of the sealed container whereby individual wipers may be removed by grasping the wiper and tearing the seam off each roll. The opening in the lid is appropriately sized to provide sufficient pressure to remove any excess liquid from each wiper as it is removed from the container.

Other suitable wiper dispensers, containers, and systems for delivering wipers are described in U.S. Pat. Nos. 5,785,179 to Buczwinski, et al.; 5,964,351 to Zander; 6,030,331 to Zander; 6,158,614 to Haynes, et al.; 6,269,969 to Huang, et al.; 6,269,970 to Huang, et al.; and 6,273,359 to Newman, et al., which are incorporated herein in their entirety by reference thereto for all purposes.

Test Procedure

Oil & Water Capacity:

The absorptive capacity refers to the capacity of a material to absorb liquid over a period of time and is related to the total amount of liquid held by a material at its point of saturation. Absorptive capacity is determined by measuring the increase in the weight of a material sample resulting from the absorption of a liquid. Absorptive capacity for both water and mineral oil were tested. The test procedure is as follows and the test is completed with the liquid at 23° C.±3° C. The liquid is distilled water and mineral oil. The mineral oil is white mineral (paraffin) having a +30 Saybolt color, NF grade 80-90 Saybolt Universal viscosity. The test procedure is as follows:

1. Specimens are cut into Four inch×four inch square samples were weighed. The weight is recorded.

2. A specimen is then submerged in 50 mm depth of the liquid for three minutes in a container large enough to allow the specimen to be completely submerged.

3. After three minutes, the specimen is remove and hung on a three-point clamp such that three of the corners are supported by a clamp and the fourth corner is hung at the as the lowest point. The specimen hangs vertically and is allowed to drain for 3 minutes for water and 5 minutes for mineral oil.

4. After draining the liquid soaked specimen, the specimen is again weighed to determine the amount of liquid absorbed by the specimen.

5. Absorptive capacity may be expressed, in percent, as the weight of liquid absorbed divided by the weight of the sample by the following equation:

Total Absorptive Capacity=[(Saturated Sample Weight−Sample Weight)/Sample Weight]×100

6. Absorptive capacity may also be express in weight basis per unit of weight of the Sample Weight Capacity=Saturated Sample Weight/Sample Weight which is expressed weight unit per weight unit.

Vertical Wicking

Vertical Wicking is a measure of the ability of a test specimen to intake a liquid. In this test, the test specimen is tested for 30 seconds to determine the distance the liquid will travel in a vertical direction in the test specimen. The data is reported in inches. The test procedure is as follows:
1. Specimens are cut into one (1) inch by eight (8) inch samples. The one inch direction will form two ends, a top end and the bottom end. The eight inch direction will be referred to as the length of the sample. The test specimens should be free of wrinkles, folds or other distortions. Test samples should be cut in both a machine direction and a cross-machine direction for this test.
2. The test fluid is placed in a pan and a ruler is placed such that the zero mark of the ruler is at the top of the liquid surface.
3. Test specimens are clamped at the top end of the specimen by a holder which will hold the specimen in place. The bottom end or free end of each test specimen (the portion placed in the fluid) may weighted with a paper clip or a binder clip so that the test specimen with be since in the test liquid. This bottom end draped over the edge of the pan to ensure that the free end will not come into contact with the test fluid.
4. The bottom end and one inch of the test specimen from the bottom end measured along the length of the specimen will be submerged into the fluid.
5. Once submerged, a time is set for 30 seconds.
6. Once 30 seconds is reached, the distance in which the fluid traveled up the length of the test specimen is noted. The test is repeated for 10 samples, and the average is reported below is each example.

### EXAMPLES

### Example 1 and Comparative Example 1

Composite nonwoven layers having a basis weight of 45 gsm were produced. As the substantially continuous thermoplastic fiber component, a polypropylene spunbond having a basis weight of 12 gsm was used. The staple fibers are Northern Softwood Kraft pulp fibers having a basis weight of about 33 gsm. Using the method described in U.S. Pat. No. 5,284,703 to Everhart, the staple fibers were entangled with the substantially continuous thermoplastic fibers. The resulting nonwoven composite has a basis weight of about 45 gsm. In addition, nonwoven composite has a first side with a preponderance of substantially continuous thermoplastic fibers and a second side with a preponderance of pulp fibers. The nonwoven composite was cut into 4 pieces. Two of the pieces were laminated together in accordance with the present invention such that the pulp rich second sides were placed adjacent to one other and were ultrasonically laminated together using an ultrasonic laminator. The ultrasonic laminator was a unit available from Hermann Ultrasonics, Inc, of Bartlett, Ill., USA. The ultrasonic laminator has a stationary horn and a rotating pattern anvil. The pattern on the anvil is Herrmann 019A. This anvil is commercially available Herrmann Ultrasonics, Inc. The power output from the horn was set to maximum power and the line speed was set at 400 feet per minute. Pressure within the nip was minimized by adjusting the gap between the horn and the anvil. The resulting nonwoven laminate had a basis weight of about 90 gsm and the outer sides of the laminate were rich with the substantially continuous thermoplastic fibers.

A second laminate as a comparison was prepared using the other two pieces of the composite. In this comparative example 1, the spunbond rich sides of each composite were placed together and laminated under the same conditions for set forth above in Example 1. The resulting nonwoven laminate had a basis weight of about 90 gsm and the outer sides of the laminate were rich with the pulp fibers.

Each laminate was tested for absorption capacity and water wicking. The results are shown in TABLE 1 below.

### Example 2 and Comparative Example 2

Example 1 and comparative Example 1 were repeated with the only difference being that the laminates were formed using a Branson Ultrasonic unit, available from Branson Ultrasonics, Inc. of Danbury, Conn., USA. Each laminate was tested for absorption capacity and water wicking. The results are shown in TABLE 1 below.

### Example 3 and Comparative Example 3

Composite nonwoven layers having a basis weight of 42 gsm were produced. As the substantially continuous thermoplastic fiber component, a polypropylene spunbond having a basis weight of 12 gsm was used. The staple fibers are Northern Softwood Kraft pulp fibers having a basis weight of about 25 gsm and polyester staple fibers at about 5 gsm. Using the method described in U.S. Pat. No. 5,284,703 to Everhart, the staple fibers were entangled with the substantially continuous thermoplastic fibers. The resulting nonwoven composite has a basis weight of about 42 gsm. In addition, nonwoven composite has a first side with a preponderance of substantially continuous thermoplastic fibers and a second side with a preponderance of staple fibers. The nonwoven composite was cut into 4 pieces. Two of the pieces were laminated together in accordance with the present invention such that a staple rich second sides was placed adjacent to a spunbond rich side and were ultrasonically laminated together using an ultrasonic laminator. The ultrasonic laminator was a unit available from a Branson Ultrasonic unit, available from Branson Ultrasonics, Inc. of Danbury, Conn., USA. The ultrasonic laminator has a stationary horn and a rotating pattern anvil. The anvil had a standard Branson DOT pattern. This anvil is commercially available Branson Ultrasonics as well. The power output from the horn was set to maximum power and the line speed was set at 75 feet per minute. Pressure within the nip was minimized by adjusting the gap between the horn and the anvil. The resulting nonwoven laminate had a basis weight of about 85 gsm and one outer side of the laminate was rich with the substantially continuous thermoplastic fibers and the other side of the laminate was rich with the staple fibers.

A second laminate as a comparison was prepared using the other two pieces of the composite. In this comparative example 3, the spunbond rich sides of each composite were placed together and laminated under the same conditions for set forth above in Example 3. The resulting nonwoven laminate had a basis weight of about 90 gsm and the outer sides of the laminate were rich with the staple fibers.

Each laminate was tested for absorption capacity and water wicking. The results are shown in TABLE 1 below.

TABLE 1

| | Total | Water | | Oil | Vertical |
|---|---|---|---|---|---|
| | Water | Capacity | Total Oil | Capacity | Wicking |
| Example | Capacity | gm/gm | Capacity | gm/gm | (30 secs) |
| Example 1 | 6.20 | 6.38 | 5.66 | 5.80 | 3.60 |
| Comp. Ex 1 | 6.20 | 6.23 | 5.86 | 5.95 | 2.40 |
| Example 2 | 5.84 | 6.43 | 5.41 | 5.88 | 2.30 |
| Comp. Ex 2 | 5.49 | 5.91 | 5.36 | 5.69 | 1.20 |
| Example 3 | 5.58 | 6.45 | 4.58 | 5.71 | 2.96 |
| Comp. Ex 3 | 5.60 | 6.40 | 4.97 | 5.63 | 2.12 |

As can be seen in Table 1, the water capacity and oil capacity of each laminate is approximately example and complementary comparative example are about the same. However, the vertical wicking for each example as compared to the complementary comparative example is vastly improved. As a result, by having the pulp rich sides of the layers of both layer of the laminate adjacent to one another, as opposed to on the outside

Although the present invention has been described with reference to various embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

1. A nonwoven laminate comprising a first composite layer and a second composite layer
said first composite layer comprising staple fibers and substantially continuous thermoplastic fibers, the first composite layer having a first outer surface and a second outer surface, wherein a preponderance of the fibers at the first outer surface of the first composite layer comprises the substantially continuous thermoplastic fibers, and a preponderance of the fibers at the second outer surface of the first composite layer the comprises staple fibers,
said second composite layer, comprising staple fibers and substantially continuous thermoplastic fibers, the second composite layer having a first outer face and a second outer face, wherein a preponderance of the fibers at a first outer face of the second composite layer comprises the substantially continuous thermoplastic fibers, and a preponderance of the fibers at a second outer face of the second composite layer comprises staple fibers
and further wherein said second outer surface of the first composite layer is adjacent said one of the first or second outer faces of the second composite layer such that the first outer surface of the first composite layer forms a first side of the nonwoven laminate.

2. The nonwoven laminate according to claim 1, wherein the first composite and the second composite layer are each hydroentangled.

3. The nonwoven laminate according to claim 1, wherein the first outer face of the second composite layer is adjacent the second outer surface of the first composite layer.

4. The nonwoven laminate according to claim 1, wherein the second outer face of the second composite layer is adjacent the second outer surface of the first composite layer.

5. The nonwoven laminate according to claim 1, wherein the staple fibers comprise absorbent staple fibers.

6. The nonwoven laminate according to claim 5, wherein the absorbent staple fibers comprise pulp fibers.

7. The nonwoven laminate according to claim 1, wherein the staple fibers comprise thermoplastic staple fibers.

8. The nonwoven laminate according to claim 7, wherein the thermoplastic staple fibers comprise polyolefin fibers, polyester fibers, polyamide fibers or a mixture thereof.

9. The nonwoven laminate according to claim 1, wherein the staple fibers comprise a mixture of thermoplastic staple fibers and non-thermoplastic absorbent staple fibers.

10. The nonwoven laminate according to claim 9, wherein the thermoplastic staple fibers comprise polyester staple fibers and the non-thermoplastic absorbent fibers comprise pulp fibers.

11. The nonwoven laminate according to claim 1, wherein the first composite and the second composite layer are each hydroentangled; and the first outer face of the second composite layer is adjacent the second outer surface of the first composite layer.

12. The nonwoven laminate according to claim 11, wherein the staple fibers comprise absorbent staple fibers.

13. The nonwoven laminate according to claim 12, wherein the absorbent staple fibers comprise pulp fibers.

14. The nonwoven laminate according to claim 11, wherein the staple fibers comprise a mixture of thermoplastic staple fibers and non-thermoplastic absorbent fibers.

15. The nonwoven laminate according to claim 14, wherein the thermoplastic staple fibers comprise polyester staple fibers and the absorbent fibers comprise pulp fibers.

16. The nonwoven laminate according to claim 1, wherein the first composite and the second composite layer are each hydroentangled; and the second outer face of the second composite layer is adjacent the second outer surface of the first composite layer.

17. The nonwoven laminate according to claim 16, wherein the staple fibers comprise absorbent staple fibers.

18. The nonwoven laminate according to claim 17, wherein the absorbent staple fibers comprise pulp fibers.

19. The nonwoven laminate according to claim 16, wherein the staple fibers comprise a mixture of thermoplastic staple fibers and non-thermoplastic absorbent fibers.

20. The nonwoven laminate according to claim 19, wherein the thermoplastic staple fibers comprise polyester staple fibers and the absorbent fibers comprise pulp fibers.

21. The nonwoven laminate according to claim 1, wherein the first composite layer and the second composite layer are ultrasonically bonded together.

22. The nonwoven laminate according to claim 1, wherein the nonwoven laminate has a basis weight between 45 and 135 gsm.

23. A wiper comprising the nonwoven laminate according to claim 1.
